(19) United States
(12) Patent Application Publication
(10) Pub. No.: US 2026/0080694 A1
(43) Pub. Date: Mar. 19, 2026

(54) DEVICES, SYSTEMS, AND METHODS FOR MONITORING CROPS AND ESTIMATING CROP YIELD

(71) Applicant: Bloomfield Robotics, Inc., Pittsburgh, PA (US)

(72) Inventors: Tim MUELLER-SIM, Pittsburgh, PA (US); Ammar SUBEI, Saint Louis, MO (US); Bhumi BHANUSHALI, Jersey City, NJ (US); Jason SIMMONS, Sacramento, CA (US); Todd KAUFMANN, Pittsburgh, PA (US); George KANTOR, Pittsburgh, PA (US)

(73) Assignee: Bloomfield Robotics, Inc., Pittsburgh, PA (US)

(21) Appl. No.: 18/994,113

(22) PCT Filed: Jul. 7, 2023
(86) PCT No.: PCT/US2023/069792

§ 371 Date: Jan. 14, 2025

Related U.S. Application Data
(60) Provisional application No. 63/368,426, filed on Jul. 14, 2022.

(51) Int. Cl. G06V 20/68; G06T 7/00; G06T 7/80; G06V 10/56; G06V 10/62; G06V 10/72; G06V 10/764; G06V 10/77; G06V 10/80; G06V 10/94; G06V 20/56; H04N 13/239; H04N 13/254

(52) U.S. Cl. CPC G06V 20/68; G06T 7/0012; G06T 7/85; G06V 10/56; G06V 10/62; G06V 10/72; G06V 10/764; G06V 10/7715; G06V 10/806; G06V 10/95; G06V 20/56; H04N 13/239; H04N 13/254; G06T 2207/10012; G06T 2207/20081; G06T 2207/30004; G06T 2207/30188; G06T 2207/30252

(57) ABSTRACT

Plant analysis system includes a vehicle configured to traverse a field in which the plant is growing and an imaging device mechanically coupled to the vehicle. Imaging device is configured to generate stereo image data associated with the plant. A back-end computer system configured to store a machine learning algorithm that, when executed by a processor, cause the back-end computer system to receive the stereo image data from the imaging device, autonomously detect an object of interest associated with the plant based on the received stereo image data, characterize the detected object of interest, and estimate a crop yield based on the characterization of the detected object of interest.

### PRIORITY CLAIM

The present application claims priority to U.S. Provisional Patent Application No. 63/368,426, titled DEVICES, SYSTEMS, AND METHODS FOR MONITORING CROPS AND ESTIMATING CROP YIELD, filed Jul. 14, 2022, the disclosure of which is incorporated by reference in its entirety herein.

### BACKGROUND

Agricultural crops can produce a desirable yield when healthy, but many factors (both natural and man-made) can reduce the health and performance of crops. Thus, farmers usually carefully manage a crop's health to ensure an optimal yield. However, when farming at a commercial scale, manually inspecting a crop and monitoring the health and performance of the crops can be extremely time consuming, costly, and inefficient. Manually monitoring crop health, growth, and yield over fields extending for acres can be extremely difficult. If the farmer hires farmhands to monitor their crops, they are subjecting themselves to the experience of the farmhands, which introduces quality risk.

### SUMMARY

In one general aspect, the present invention is directed to a plant analysis system. The plant analysis system can include a vehicle configured to traverse a field in which the plant is growing and an imaging device mechanically coupled to the vehicle, wherein the imaging device is configured to generate stereo image data associated with the plant. The plant analysis system can further include a back-end computer system with a processor and a memory configured to store a machine learning algorithm that, when executed by the processor, cause the back-end computer system to receive the stereo image data from the imaging device, autonomously detect an object of interest associated with the plant based on the received stereo image data, characterize the detected object of interest, and estimate a crop yield based on the characterization of the detected object of interest.

In another general aspect, the present invention is directed to a method of analyzing a plant. The method can include the step of receiving, via a processor, stereo image data generated by an imaging device mechanically coupled to a vehicle configured to traverse a field in which the plant is growing. The imaging device can be configured to generate stereo image data associated with the plant. The method can also include the step of autonomously detecting, via the processor, a fruit associated with the plant based on the received stereo image data. The method can further include the step of characterizing, via the processor, the detected fruit, estimating, via the processor, a crop yield based on the characterization of the detected fruit. The method can also include the step of optimizing a harvest of the fruit based on the estimated crop yield.

### FIGURES

Various embodiments are described herein by way of example in connection with the following figures.

FIG. 1A illustrates a plant analysis system, including an imaging device and a back-end computing system, in accordance with at least one non-limiting aspect of the present invention;

FIG. 1B illustrates a front perspective of the imaging device of the plant analysis system of FIG. 1A, in accordance with at least one non-limiting aspect of the present invention;

FIG. 2 illustrates a system diagram of the imaging device configured for use with the plant analysis system of FIG. 1, in accordance with at least one non-limiting aspect of the present invention;

FIG. 3 illustrates a system diagram of the back-end computer system configured for use with the plant analysis system of FIG. 1, according to at least one non-limiting aspect of the present invention;

FIG. 4, illustrates a block diagram of a farm capable of being monitored by the plant analysis system of FIG. 1, in accordance with at least one non-limiting aspect of the present invention;

FIG. 5 illustrates a flow diagram of an algorithmic method executed by the back-end computer system of FIG. 3, in accordance with at least one non-limiting aspect of the present invention;

FIG. 6 illustrates a flow diagram of a method performed by the plant analysis system of FIG. 1, in accordance with at least one non-limiting aspect of the present invention; and

FIG. 7 illustrates a user interface configured to display an automated crop analysis generated by captured image data generated by the system of FIG. 1, in accordance with at least on non-limiting aspect of the present invention.

### DESCRIPTION

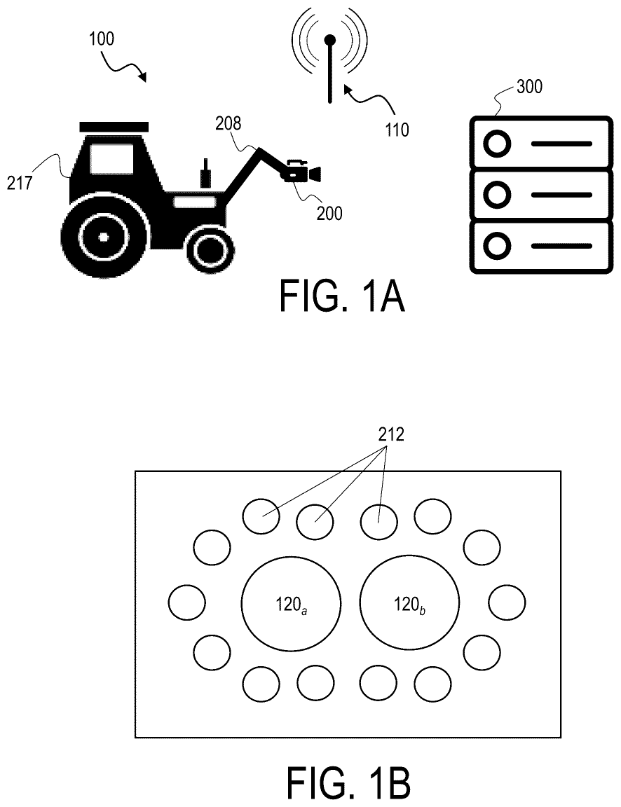

Referring now to FIG. 1A, a plant analysis system 100 is shown in accordance with at least one non-limiting aspect of the present invention. Specifically, the plant analysis system 100 of FIG. 1 can include an imaging device 200 that is communicably connectable to a back-end computer system 300 via a data network 1 10, which may comprise a LAN, WAN, the Internet, etc. The imaging device 200 may be, for example, in wireless communication with a device that is connection to the data network 110, such as to a router or wireless access point via a WiFi data link or a to a mobile device (e.g., smartphone, tablet computer, laptop, etc.) via a Bluetooth, Bluetooth Low Energy, Zigbee, MQTT, or Mosquitto communication link, for example. The imaging device 200 can be programmed to capture, process, and transmit images 106 of the plants with features being assessed to the back-end computer system 300. The back-end computer system 300 can in turn be programmed to analyze plant features within the images 106 and calculate parameters associated with the plant features to assist users in determining whether to harvest the plants. The analysis and/or parameter determinations can be performed using, at least in part, machine learning.

The plant analysis system 100 generally functions by, for example, capturing a series of images of a plant or portions thereof at, combining the captured images using focus stacking techniques to ensure the appropriate sharpness for the analyzed images, analyzing the focus stacked images to identify particular plant features, and then providing the user with various parameters and/or recommendations based on the identified plant features. Plants can be analyzed according to a number of different features. In some aspects, the plant analysis system 100 can employ computer vision and artificial intelligence algorithms to determine a position of a plant relative to the imaging device 200 and detect and characterize objects of interest (e.g., fruits, vegetables, clusters, etc.) to determine maturity and predict an estimated yield of a particular plant, row, field, or farm. Focus may be set to a wide depth of field by adjusting an aperture of the imaging device 200 to a small size (e.g., F/12 or higher, etc.). However, according to some non-limiting aspects, the plant analysis system 100 can adjust focus distances.

In reference to FIG. 1B, a front perspective of the imaging device 200 of the plant analysis system 100 of FIG. 1A is depicted in accordance with at least one non-limiting aspect of the present invention. According to the non-limiting aspect of FIG. 1B, the imaging device 200 can be a stereo camera featuring a first lens 120a and a second lens 120b surrounded by a plurality of light emitting diodes (“LEDs”) 212. The first lens 120a and the second lens 120_{b} can be set a fixed distance from one another, thereby defining a fixed leg upon which triangulation computations to determine depth in an image, including a distance from which an object of interest is positioned from the camera. In other words, the imaging device 200 of FIGS. 1A and 1B can closely copy human eyes, to produce accurate, real-time depth perception.

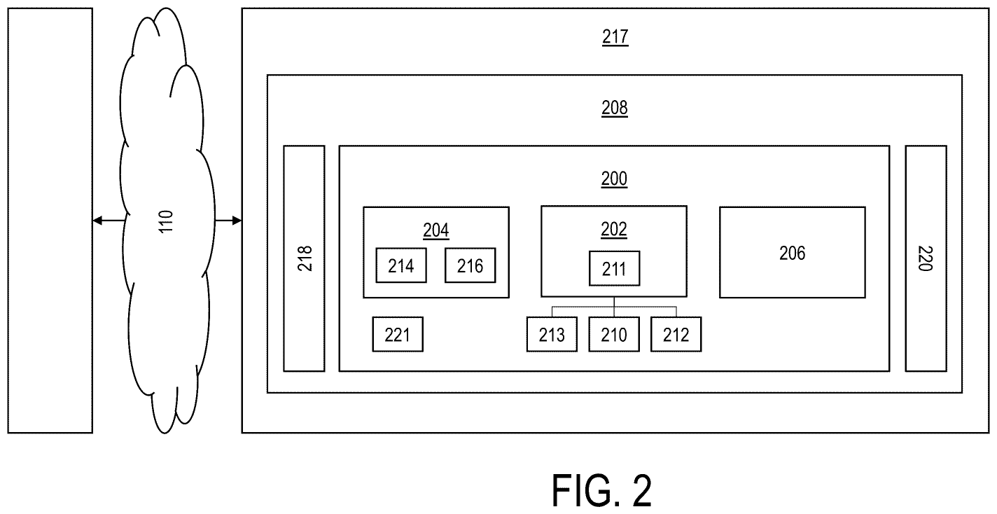

Referring now to FIG. 2, a system diagram of an imaging device 200 configured for use with the plant analysis system 100 of FIG. 1 is depicted in accordance with at least one non-limiting aspect of the present invention. As previously discussed with reference to FIG. 1, the imaging device 200 of FIG. 2 can be configured to communicate with a back-end computer system 300 via wireless communication across a data network 110. However, according to the non-limiting aspect of FIG. 2, the imaging device 200 can include a light emitting diode (“LED”) overdrive circuit 202, a hardware synchronization circuit 204, and a memory 206. For example, the LED overdrive circuit 202 can be communicably coupled to a capacitor 210 and an LED light 212 and configured to control the capacitor's 210 discharge to safely drive at least one LED light 212 for a short and precisely timed period of time. It shall be appreciated that lighting is a fundamental component of any machine vision-based system, such as the plant analysis system 100 of FIG. 1, because even the best cameras can only process and contextualize a scene with sufficient levels of reflected light via corresponding image processing software. Therefore, the quality of illumination, including stability, repeatability, and the illumination intensity, can be essential for any type of machine vision-based application.

Accordingly, the LED overdrive circuit 202 can enable the imaging device 200 of FIG. 2 to capture high quality images at high speeds, exceeding the capabilities of a conventional flash on a convention camera. For example, according to some non-limiting aspects, the LED overdrive circuit 202 can be configured to drive the LED light 212 at 1 μs pulses of hundreds of amps via a low-value current limiting resistor (not shown). As such, the LED overdrive circuit 202 can overdrive the LED light 212 by a factor of 10, for relatively short pulse lengths. Since the LED overdrive circuit 202 can produce microsecond flashes, the imaging device 200 can essentially “freeze” images, even if the imaging device 200 is traveling at relatively high speeds. According to some non-limiting aspects, the LED overdrive circuit 202 can be further coupled to a light sensor 213, which can be configured to detect ambient light and thus, further influence the degree to which the LED overdrive circuit 202 drives the LED light 212. According to still other non-limiting aspects, the LED overdrive circuit 202 can further include a circuit protection diode 211 to protect the LED overdrive circuit 202 from overdriving to a degree that the capacitor 210, the LED light 212, and/or the LED overdrive circuit 202 itself can be damaged.

Still referring to FIG. 2, the imaging device 200 can further include a hardware synchronization circuit 204, which can further include a microcontroller 214 and one or more hardware interfaces 216, which can be collectively configured to precisely synchronize at least two or more components and/or functions of the imaging device 200 and/or the plant analysis system 100 of FIG. 1. For example, the hardware synchronization circuit 204 can synchronize flash lighting via the LED overdrive circuit 202, other imaging functions performed by the imaging device 200, global positioning system (“GPS”) functionality, and/or other functions executed by software and firmware stored in the memory 206 of the imaging device 200, as the imaging device 200 traverses a field. As such, the hardware synchronization circuit 204 can ensure the imaging device 200 is only capturing images-for example, via the LED overdrive circuit 202—when it is positioned in the right location of a field and oriented at an object of interest (e.g., a plant). According to some non-limiting aspects, a system 100 (FIG. 1) can employ two or more imaging units 200 and a single hardware synchronization circuit 204 can be utilized to synchronize functions across the two or more imaging units 200.

In further reference to FIG. 2, the imaging device 200 can further include a memory 206 configured to store data, software, and/or firmware to support the functionality of the imaging device 200. For example, the memory 206 can be configured to store firmware to facilitate the aforementioned synchronization of component and system functions via the hardware synchronization circuit 204. Additionally and/or alternatively, the memory 206 can be configured to store software to estimate the imaging device's 200 position and/or orientation (“POSE”) within its environment (e.g., a field) based on captured image data and/or other sensor inputs generated and received. According to some non-limiting aspects, the software can be configured to estimate the imaging device's POSE relative to a vehicle 217 and the system 100 can employ GPS and/or an IMU to determine the position of the vehicle 217 relative to environment (e.g., plant, row, farm, etc.). According to other non-limiting aspects, such software can be stored on a remotely located server for off-site POSE estimations. For example, according to some non-limiting aspects, POSE can be estimated using individual images captured by the imaging device 200 by constantly tracking four fixed feature points in a particular pattern, whose positions are known a priori. According to other non-limiting aspects, POSE can be estimated using techniques such as visual odometry.

The imaging device 200 of FIG. 2 can be further mounted to a modular mounting system 208. The modular mounting system 208 can include an arrangement of mechanical components (e.g., platforms, mechanisms, fasteners, etc.) configured to secure the imaging device 200 for transport through an environment (e.g., a field). For example, the modular mounting system 208 can secure the imaging device 200 to a vehicle 217, including farm-specific vehicles, such as tractors. According to other non-limiting aspects, the modular mounting system 208 can be configured to secure the imaging device 200 to an autonomous vehicle, such as a ground and/or air-based drone. The modular mounting system 208 can be further configured to prevent various cables coupled to the imaging device 200 from dragging and/or snagging on objects (e.g., plants, vehicle components, etc.). The modular mounting system 208 can, therefore, limit damage to the system 100 and can enable it to maintain power/communication to the vehicle and other imaging devices 200 without restriction in most farm environments. As such, the modular mounting system 208 can prevent damage to the imaging device 200 as the imaging device 200 and vehicle 217 traverse the field.

According to some non-limiting aspects, the modular mounting system 208 can include an enclosure configured to encompass at least a portion of the imaging device 200 and secure the imaging device 200 to a vehicle 217. Such an enclosure of the modular mounting system 208 can optionally include an auxiliary power source 218 configured to store and provide electrical power to the imaging device 200 via a wired and/or wireless connection. According to some non-limiting aspects, the auxiliary power source 218 can be rechargeable. According to other non-limiting aspects, the auxiliary power source 218 can be coupled to a power source of the vehicle 217 itself and thus, merely serve as a conduit through which power can be supplied from the vehicle 217 to the imaging device 200. According to still other non-limiting aspects, the imaging device 200 itself can include a power source (not shown) and only rely on the auxiliary power source 218 when its power drops below a predetermined threshold.

According to other non-limiting aspects, the enclosure of the modular mounting system 208 can further include a backup memory 220 communicably coupled to the memory 206 of the imaging device 200. The backup memory 220 can be configured to store logs, captured image data, software, firmware, and/or any other information necessary to facilitate the effective operation of the imaging device 200. As such, the backup memory 220 can be configured such that the memory 206 of the imaging device 200 can offload such information to the backup memory 206, as necessary. According to some non-limiting aspects, such offloading can occur in real-time. According to other non-limiting aspects, offloading can occur when the memory 106 of the imaging device 200 meets or exceeds a predetermined capacity threshold.

According to still other non-limiting aspects, software stored in the memory 206 of the imaging device 200 can be configured to run in real-time and automatically detect (e.g., via the imaging device 200, a GPS unit, combinations thereof, etc.) when a vehicle 217 that the imaging device 200 is mounted to (via the modular mounting system 208, for example) transitions from a first row of crops to a second row of crops. Accordingly, the software can conclude a protocol for the first row of crops, and initiate a protocol of the imaging device 200 for the second row of crops. In other words, software stored in the memory 206 of the imaging device 200 can be configured for auto-log segmentation, attributing captured image data to specific locations (e.g., rows) within an environment (e.g., a field). Once again, according to other non-limiting aspects, the software can be stored on a remotely located server for off-site auto-log segmentation. The imaging device 200 can further include a global positioning system (“GPS”) transceiver 221 configured to generate location information that can be stored in the memory 206 and attributed to captured image data generated by the imaging device 200. Of course, according to some non-limiting aspects, the GPS transceiver 221 can be coupled to the vehicle 217 but nonetheless communicably coupled to the memory 206.

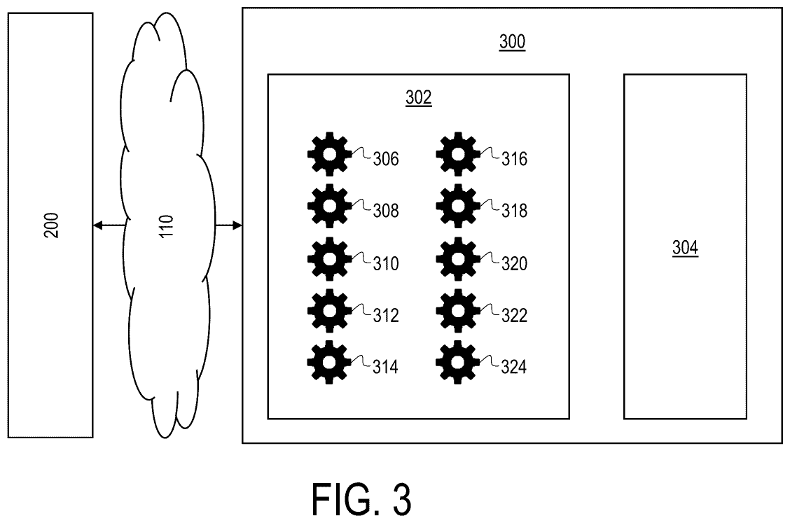

It shall be appreciated that the plant analysis system 100 (FIG. 1)—and specifically, the imaging device 200—represent hardware innovations that can be implemented to collect high-quality, high-resolution images in the field via a moving platform under varying lighting conditions. Moreover, the plant analysis system 100 (FIG. 1) can generate data that is optimized for machine learning algorithms that can be used to phenotype plants and identify typical objects on the farm (e.g., posts, trellis wires, etc.). Referring now to the back-end computer system 300, a pipeline of processes for processing captured image data to determine the health and/or performance of the imaged crops at any level (e.g., a single plant, a row of plants, a block of plants, an entire farm, etc.) will be described in further detail. Although the pipeline is described as executed via software stored on a remotely located or “cloud-based” back-end computer system 300 (FIG. 3), it shall be appreciated that, according to some non-limiting aspects, the pipeline can be locally implemented via software stored in the memory 206 of the imaging device 200. Of course, according to other non-limiting aspects, the pipeline can be implemented by a combination of software executed by a remotely-located, back-end computer system 300 and software stored in the memory 206 of the imaging device 200. The determined results can be subsequently transmitted and displayed to an end user using a variety of means, which will also be described in further detail herein.

Referring now to FIG. 3, a back-end computer system 300 configured for use with the plant analysis system 100 of FIG. 1 is depicted in accordance with at least one non-limiting aspect of the present invention. As previously discussed, the back-end computer system 300 can be remotely located relative to the imaging device 200 (FIG. 2), but nonetheless configured for wireless and/or wired communication with the imaging device 200 (FIG. 2). According to the non-limiting aspect of FIG. 3, the back-end computer system 300 can include at least one memory 302 and at least one processor 304 configured to execute software stored on the memory 302.

The memory 302 of the back-end computer system 300 can be configured to store a plurality of engines 306, 308, 310, 312, 324, 326, 328, 320, 322, 324, which are particularly configured to collectively cause the processor 304 to execute the pipeline of processes for processing captured image data to determine the health and/or performance of the imaged crops. For example, the memory 302 can store an internet-of-things (“IoT”) stream processing and automated log extraction engine 306 configured to automatically process logs of captured image data into data products for further processing. The IoT stream processing and automated log extraction engine 306 can be further configured to generate and organize metadata associated with the captured image data and can synchronize results with an internal customer database (not shown). The internal customer database (not shown), for example, can store image file locations, each with associated pose and objects detected in the image, along with other sensor data and diagnostic information about the state of the imaging device 200 at the time an image was captured. The memory can further store an image rectification engine 308 configured to automatically correct lens distortion associated with captured image data. For example, in order to meet the demands of a machine vision application, image data capture must faithfully reproduce the object of interest (e.g., a plant, a leaf of a plant, a branch of a plant, a fruit on a plant, a vegetable on a plant, an object or discoloration on a plant, etc.) being imaged. Accordingly, the image rectification engine 308 is programmed to detect and understand the effects of lens distortion evaluate its effect, rectify it such that the accuracy of the captured image data is enhanced.

Still referring to FIG. 3, the memory 302 can further store an image calibration engine 310 configured to automatically correct various parameters (e.g., a color, a brightness, a contrast, etc.) of the captured image data based on one or more adaptive image correction algorithms. The memory 302 can further store a stereo image engine 312 configured to compute disparity images and associated depth maps based on the rectified, calibrated captured image date. In other words, the stereo image engine 312 can extract three-dimensional information from the partially-processed captured image data by comparing information about a captured object of interest object of interest (e.g., a plant, a leaf of a plant, a branch of a plant, a fruit on a plant, a vegetable on a plant, an object or discoloration on a plant, etc.) from captured image data representing two different vantage points of the same object of interest. Accordingly, the stereo image engine 312 can examine the relative positions of the object of interest—and more specifically, the position of the object of interest relative to the imaging device 200 (FIG. 2). For example, the stereo image engine 312 can determine a distance between an object of interest and the camera when the captured image data was generated by the imaging device 200 (FIG. 2).

The memory 302 can further store an image mosaic cropping engine 314 configured to estimate an overlap between captured image data in a temporal sequence and subsequently crop the captured image data to eliminate overlapping parts. After the image mosaic cropping engine 314 crops the captured image data, each datum of the captured image data represents a unique part of a scene, with minimal overlap relative to adjacent datum in the temporal sequence. According to some non-limiting aspects, the image mosaic cropping engine 314 can utilize depth information derived from the stereo image engine 312 to further minimize overlap between adjacent datum in the temporal sequence.

In further reference to FIG. 3, the memory 302 can further store a deep net feature extraction and instance segmentation engine 316 configured to provide supervised learning to detect features with bounding boxes and can further provide pixel-wise segmentations of feature instances. Specifically, the deep net feature extraction and instance segmentation engine 316 can use a plurality of algorithmic processing layers to identify and categorize key features (e.g., size, color, age, plant type, etc.) of objects within the captured image data. For example, the deep net feature extraction and instance segmentation engine 316 can include a deep feed forward (“DFF”), a convolutional neural network (“CNN”), a residual neural network (“ResNet”), a U-Net neural network, a YOLO neural network, and/or a generative adversarial network, amongst others, to identify and extract such features from the captured image data.

According to the non-limiting aspect of FIG. 3, the memory 302 can further store an iterative train-label cycle engine 318 configured to iteratively train the algorithmic, deep networks implemented in the deep net feature extraction and instance segmentation engine 316. The iterative train-label cycle engine 318 can receive a user input that includes a small set of initial training data. Subsequently, the iterative train-label cycle engine 318 can be configured to use the initial training data to train an initial model stored by the iterative train-label cycle engine 318. The model produces outputs, which can be reviewed by a user, who corrects any mistakes made by the model, adds the corrections to the training set, and provides the corrected training set back to the iterative train-label cycle engine 318. The iterative train-label cycle engine 318 proceeds to retrain the model. The iterative train-label cycle engine 318 repeats this process until sufficient model performance is achieved, with successively less effort required by the human labelers in each iteration. Ultimately, the iterative train-label cycle engine 318 and the deep net feature extraction and instance segmentation engine 316 are configured to autonomously analyze and classify objects, and improve its analysis and classification, while reducing the need for programmer intervention.

The memory 302 of FIG. 3 can further store an image feature to yield analytical engine 320 configured to estimate the health and/or yield at varying levels (e.g., a single plant, a row of plants, a block of plants, an entire farm, etc.) based on captured image data associated with various objects of interest (e.g., a plant, a leaf of a plant, a branch of a plant, a fruit on a plant, a vegetable on a plant, an object or discoloration on a plant, etc.).

Specifically, the yield analytical engine 320 can make such determinations based on received inputs from the stereo image engine 312 and the deep net feature extraction and instance segmentation engine 316. The stereo image engine 312, for example, can output an estimated distance between the object of interest and the imaging device 200 (FIG. 2) to the yield analytical engine 320 and the deep net feature extraction and instance segmentation engine 316, for example, can output features (e.g., size, color, age, plant type, etc.) of the object of interest the yield analytical engine 320, as extracted from the captured image data. According to some non-limiting aspects, the yield analytical engine 320 can receive outputs from the image mosaic techniques cropping engine 314 to eliminate overlap from the captured image data.

The yield analytical engine 320 can reconcile inputs from the stereo image engine 312, the deep net feature extraction and instance segmentation engine 316, and the image mosaic techniques cropping engine 314 to identify the actual size and color of the objects of interest on a plant, in a field, or on a farm and thus, can generate an accurate estimation of the health, age, ripeness and, ultimately, yield expected from a crop at those levels. For example, the yield analytical engine 320 can estimate the number, size, and color of grapes and/or grape clusters on a vineyard and can conclude that either the vineyard, a particular field of the vineyard, a particular row in the field, or a particular plant in the row is ready to harvest. It shall be appreciated that the combination of the stereo image engine 312 and the deep net feature extraction and instance segmentation engine 316 enables the aforementioned benefits, as without an accurate determination of the distance between the object of interest and the imaging device 200, the estimation of certain features (e.g., size, color, etc.) can not be sufficiently determined. Accordingly, the back-end computer system 300 and the imaging device 200 (FIG. 2) collectively represent a technological improvement.

According to the non-limiting aspect of FIG. 3, the memory 302 can further store a geospatial visualization engine 324 configured to visualize the spatial arrangement of points in a log file based on GPS data generated by the plant visualization system 100 or imaging device 200. This can include capabilities to overlay features extracted by the deep net feature extraction and instance segmentation engine 316 and messages generated by the yield analytical engine 320 onto maps generated by the geospatial visualization engine 324.

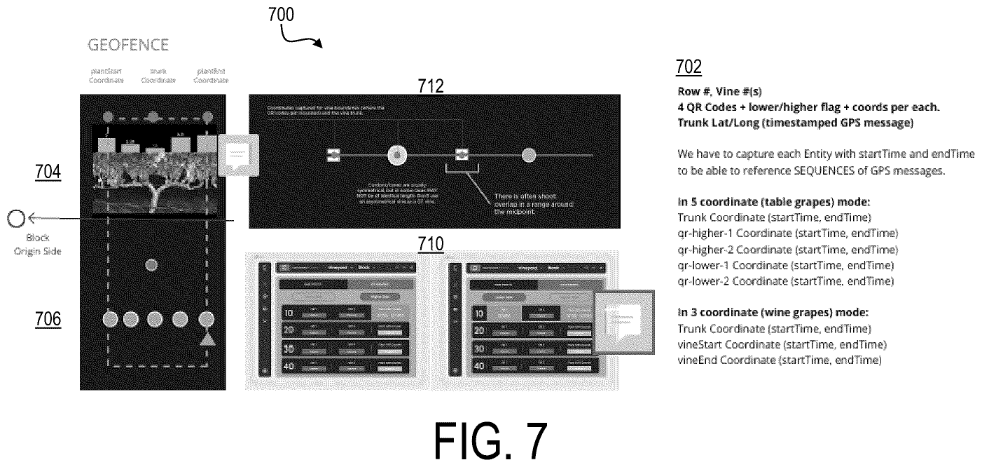

Still referring to FIG. 3, the memory 302 can further store an image analysis interface engine 322 configured to cause a display communicably coupled to the back-end computer system 300 to display a log and/or imaged (either cropped or uncropped) of the objects of interest by plant, row, field, or farm. A non-limiting example of one such a display 704 is presented in FIG. 7. The display, for example, can be a monitor plugged into the back-end computer system 300 or a laptop, phone, or tablet configured for wireless communication with the back-end computer system 300. The image analysis interface engine 322 can be further configured to receive user inputs, which can enable a user to toggle through various overlays generated by the image analysis interface engine 322. Each overlay can illustrate features of the object of interest, as extracted from the captured image data by the deep net feature extraction and instance segmentation engine 316. Various overlays generated by the image analysis interface engine 322 may include textual alerts, messages, images, and/or other communications of messages generated by the yield analytical engine 320, which the user can toggle through and assess by feature, plant, row, field, and/or farm. At least one overlay can include a map generated by the geospatial visualization engine 324.

The back-end computer system 300 may comprise one or multiple processing CPU cores. One set of cores could execute the program instructions for the various engines 306, 308, 310, 312, 324, 326, 328, 320, 322, 324. The program instructions could be stored in computer memory that is accessible by the processing cores, such as RAM, ROM, processor registers or processor cache, for example. In other embodiments, the processors of the back-end computer system may comprise graphical processing unit (GPU) cores, e.g. a general-purpose GPU (GPGPU) pipeline. GPU cores operate in parallel and, hence, can typically process data more efficiently that a collection of CPU cores, but all the cores execute the same code at one time. The computer devices (e.g., servers) that implement the back-end computer system 300 may be remote from each other and interconnected by data networks, such as a LAN, WAN, the Internet, etc., using suitable wired and/or wireless data communication links. Data may be shared between the various systems using suitable data links, such as data buses (preferably high-speed data buses) or network links (e.g., Ethernet).

The software for the various engines described herein (e.g., the engines 306, 308, 310, 312, 324, 326, 328, 320, 322, 324) and other computer functions described herein may be implemented in computer software using any suitable computer programming language such as. NET; C, C++, Python, and using conventional, functional, or object-oriented techniques. For example, the various machine learning systems may be implemented with software modules stored or otherwise maintained in computer readable media, e.g., RAM, ROM, secondary storage, etc. One or more processing cores (e.g., CPU or GPU cores) of the machine learning system may then execute the software modules to implement the function of the respective machine learning system (e.g., student, coach, etc.). Programming languages for computer software and other computer-implemented instructions may be translated into machine language by a compiler or an assembler before execution and/or may be translated directly at run time by an interpreter, Examples of assembly languages include ARM, MIPS, and x86; examples of high level languages include Ada, BASIC, C, C++, C#, COBOL, Fortran, Java, Lisp, Pascal, Object Pascal, Haskell, M I; and examples of scripting languages include Bourne script, JavaScript, Python, Ruby, Lua, PHP, and Perl.

As previously discussed, the plant analysis system 100 (FIG. 1)—and specifically, the imaging device 200 (FIG. 2)—in connection with the back-end computer system 300 of FIG. 3 can be implemented not only to collect high-quality, high-resolution images in a field, but to extract features which can be used to autonomously generate conclusions about the health and yield of plants grown on a farm. However, certain operational innovations contemplated by the present invention can provide further improve generation of captured image data via an imaging device 200 (FIG. 2) on the field, imbue it with even more information, and provide even more enhanced insights regarding crop age, health, and/or yield.

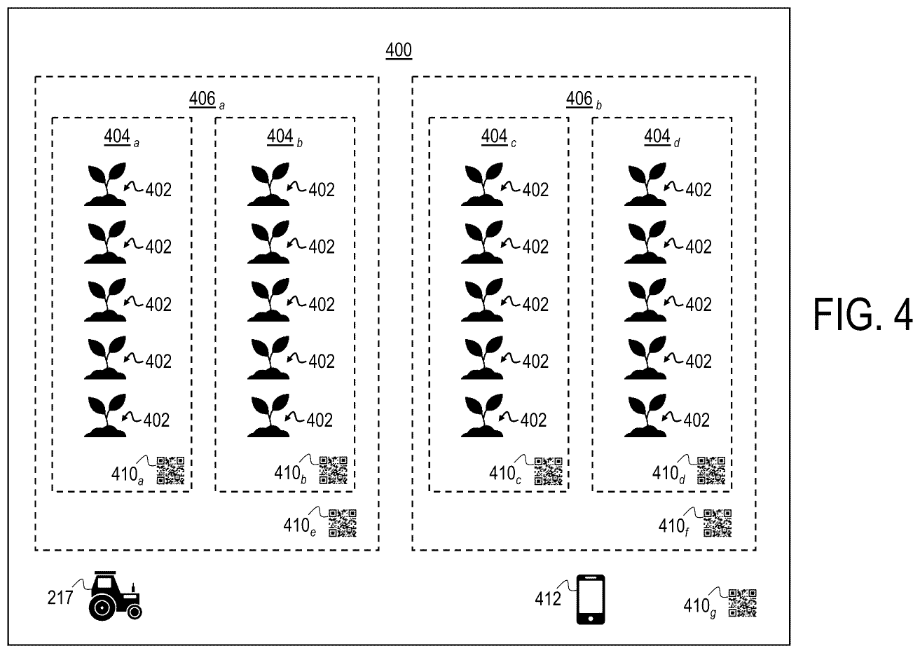

For example, referring now to FIG. 4, a block diagram of a farm 400 is depicted in accordance with at least one non-limiting aspect of the present invention. According to the non-limiting aspect of FIG. 4, the farm 400 can include a plurality of plants 402 arranged in a plurality of rows 404_{a-d} dispersed across two fields 406ₐ, 406_{b}. As illustrated in FIG. 4, a vehicle 217, on which an imaging device, such as the imaging device 100 of FIG. 1 or imaging device 200 of FIG. 2, is mounted via a modular mounting system, such as the modular mounting system 208 of FIG. 2. The farm may include one or more location indicators 410_{a-g} that can be imaged by the imaging device 200 (FIG. 2). According to some non-limiting aspects, the indicators 410_{a-g} can include a quick response (“QR”) code attributed with a specific row 410ₐ₋ₑ, a QR code attributed with a specific field 412ₑ, 410_{f}, or a QR code attributed with a specific farm 410_{g}. As the vehicle 217 traverses the farm 400, the imaging device 200 (FIG. 2) can generate captured image data that includes the indicators 410_{a-g}, which can be used to categorize and sort the captured image data. For example, the indicators 410_{a-g} can be extracted as features by the deep net feature extraction and instance segmentation engine 316 (FIG. 3) and interpreted by the yield analytical engine 320 and/or geospatial visualization engine 324 of the back-end computer system 300 (FIG. 3) to specifically locate captured image data by row, field, or farm. This can assist with calibration plotting, row identification, and/or block identification. Likewise, the system 100 (FIG. 1) can employ ground truth and/or calibration protocols configured to count and size a specific crop (e.g., grape berries, grape clusters, etc.) within a specified calibration plot.

According to some non-limiting aspects, the indicators 410_{a-g}, such as QR codes on the vines, can be used to calibrate the system. For example, personnel on the ground can perform a process of “ground truthing” by scanning the indicators 410_{a-g}, counting berries and/or clusters on a branch associated with each indicator 410_{a-g}, and then using the personnel-generated data to calibrate autonomously-generated data. When an indicator 410_{a-g} is scanned, it can trigger an algorithmic model to confirm what the system autonomously based on what the “ground truth” personnel found manually in the field. For example, the system may determine that a 2:1 ratio of existing to visible berries/vines exists in association with a particular indicators 410_{a-g}. Thus, the system can use personnel-generated data in conjunction with the indicators 410_{a-g} as benchmarks extrapolated across an entire row 406_{a-d}, field 404ₐ, 404_{b}, and/or farm 400, etc. It shall be appreciated that such personnel-generate data is not necessary for the entire farm 400. Rather, a de minimis number of vines (e.g., 5 vines) can be used to enhance the accuracy of data generated across the entire row 406_{a-d}, field 404ₐ, 404_{b}, and/or farm 400, etc. Additionally, the indicators 410_{a-g}, can be more strategically positioned, to assess a specific density of vines or assess the yield of a particular soil type/location. Strategically locating the indicators 410_{a-g} can enable a user to isolate certain conditions to attenuate and enhance the extrapolation, accommodating for certain conditions.

Additionally, the system 100 (FIG. 1) can integrate with a mobile computing device 412 of a user, for the automated and/or manual entry of metadata associated with images captured by the imaging device 200 (FIG. 2) as it traverses the farm 400 on the vehicle 217. For example the mobile computing device 412 (e.g., a cell phone, a smart phone, a tablet, and/or a laptop computer, etc.) can be used to attribute crop types, farm names, row identification numbers, and/or camera configuration information to captured image data, amongst others. The mobile computing device 408 can also be used to attribute location information to captured image data based on features inherent to the mobile computing device 412 (e.g., accelerometers, GPS features, etc.). For example, the mobile computing device 412 can be configured to display a user interface, such as the user interface 700 of FIG. 7.

Referring now to FIG. 7, a user interface 700 configured to display an automated crop analysis generated by captured image data generated by the system 100 of FIG. 1 is depicted in accordance with at least on non-limiting aspect of the present invention. The user interface 700 can be viewed, for example, by a tablet of a user on the farm 400 of FIG. 4. According to the non-limiting aspect of FIG. 7, the user interface 700 can include one or more widgets 702, 704, 706, 708, 710 configured to display the captured image data and/or analytical results generated by the system 100 of FIG. 1 in real-time. The user interface 700 can further be configured to scan indicators 410_{a-g} and/or receive personnel inputs for the aforementioned calibration process. For example, the user interface 700 can include a widget 704 to display captured image data of a plant, as well as information regarding cluster and health of the crops available at various locations of the plant. The user is scanning the QR code with the camera on the tablet, and then is entering the specific GPS coordinate of the QR code. The user interface 700 can further include a widget 708 configured to display plant trunk, shoot, and/or vine information. This can be useful because, although plants are sometimes symmetrical, having a characterization of the plant can account for overlapping vines or shoots, asymmetrical growths, and/or irregular lengths. Yet another widget 710 can be used to keep track of GPS coordinates by row 406_{a-d}, field 404ₐ, 404_{b}, and/or farm 400. For example, where the first widget 704 displays personnel-generated data, the user can select GPS coordinates for a particular row 406_{a-d}, field 404ₐ, 404_{b}, and/or farm 400 or scan an indicator 410_{a-g} prior to entering data. Accordingly, the system 100 can attribute a set of data to the correct location where it was captured on the farm 400. Another widget 702 displays various modes associated with various crops being monitored by the system 100 of FIG. 1. For example, the system 100 can be set to monitor table grapes or wine grapes and thus, the estimations and/or modeling can be automatically adjusted. According to some non-limiting aspects, based on the determined starts and ends defined via the user interface 700 of FIG. 7, the system 100 (FIG. 1) can determine the vines in a block and determine where to strategically locate indicators 410_{a-g}. For example, the system 100 (FIG. 1) may determine which vines, rows etc. would serve as the best benchmarks for extrapolation.

According to still other non-limiting aspects, the system 100 (FIG. 1) can employ data offload and/or cloud transport protocols to offload captured image data from the imaging device 200 (FIG. 2) to the back-end computer system 300 (FIG. 3) for processing via the pipeline executed by the engines 306, 308, 310, 312, 314, 316, 318, 320, 322, 324. For example, the imaging device 200 (FIG. 2) can include a removable hard drive, the imaging device 200 (FIG. 2) can be communicably coupled to a local server communicably coupled to the back-end computer system 300 (FIG. 2), and/or software stored in the memory 206 (FIG. 2) of the imaging device 200 (FIG. 2) can be configured to automatically upload captured image data by row, field, or farm based on a detection of indicators 410_{a-g}. The system 100 (FIG. 1) can further employ remote support connectivity, or a collection of tools configured to monitor a status of the imaging device 200 (FIG. 2) and provide troubleshooting support via a communication channel, such as a low bandwidth cellular connection positioned onboard the imaging device 200, itself.

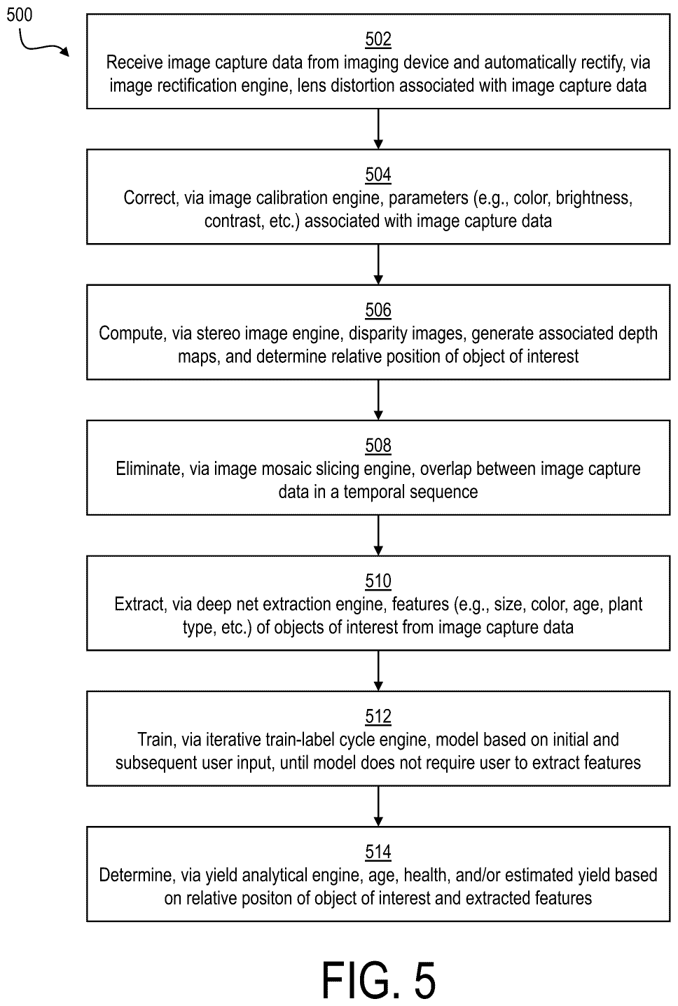

Referring now to FIG. 5, a flow diagram of an algorithmic method 500 executed by the back-end computer system 300 of FIG. 3 is depicted in accordance with at least one non-limiting aspect of the present invention. According to the non-limiting aspect of FIG. 5, the method 500 can include receiving captured image data from imaging device, such as the imaging device 200 of FIG. 2, and automatically rectifying 502, via the image rectification engine 308 (FIG. 3), lens distortion associated with captured image data. The image calibration engine 310 (FIG. 3) can then correct 504 parameters (e.g., color, brightness, contrast, etc.) associated with captured image data, after which the stereo image engine 312 (FIG. 3) can compute 506 disparity images, generate associated depth maps, and determine relative position (e.g., a globally referenced or “absolute” position, etc.) of object of interest (e.g., a distance to the imaging device 200 of FIG. 2).

The method 500 of FIG. 5 can further include eliminating 508, via image mosaic cropping engine 314 (FIG. 3), overlap between captured image data in a temporal sequence and extracting 510, via deep net extraction engine 316 (FIG. 3), features (e.g., size, color, age, plant type, etc.) of objects of interest from captured image data. Finally, the method 500 can include determining 514, via yield analytical engine 320 (FIG. 3), an age, health, and/or estimated yield based on relative position of object of interest and extracted features.

According to some non-limiting aspects, the iterative train-label cycle engine 318 (FIG. 3) can train 512 a model based on initial and subsequent user input, until model does not require user to extract features.

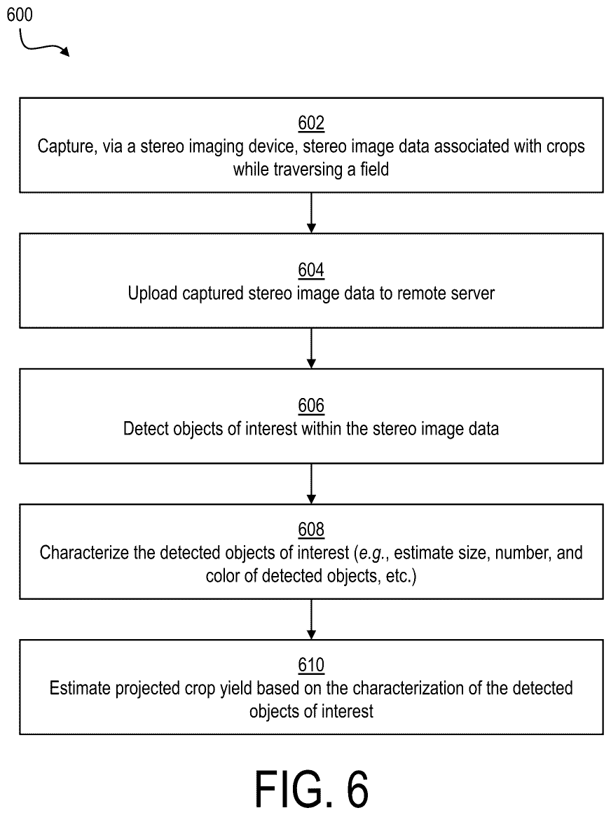

Referring now to FIG. 6, illustrates a flow diagram of a method 600 performed by the plant analysis system 100 of FIG. 1 is depicted in accordance with at least one non-limiting aspect of the present invention. According to the non-limiting aspect of FIG. 6, the method 600 can include capturing 602, via the imaging device 200 of FIG. 2, stereo image data associated with crops while traversing a field and uploading 604 captured stereo image data to the back-end computing system 300 (FIG. 3). The method 600 can further include detecting 606, via the back-end computing system 300 (FIG. 3), objects of interest within the stereo image data and characterizing 608, via the back-end computing system 300 (FIG. 3), the detected objects of interest (e.g., estimate size, number, and color of detected objects, etc.). The method 600 can further include estimating 610, via the back-end computing system 300 (FIG. 3), a projected crop yield based on the characterization of the detected objects of interest.

It shall be appreciated the steps of the methods 500, 600 (FIGS. 5 and 6) described herein are non-exclusive and merely exemplary. Accordingly, it shall be appreciated that the methods 500, 600 (FIGS. 5 and 6) can be modified to include any of the functions discussed herein, as attributed with any of the components, devices, and/or systems described in reference to the non-limiting aspects of FIGS. 1-4.

Examples of the system and method according to various aspects of the present invention are provided below in the following numbered clauses. An aspect of the system and method may include any one or more than one, and any combination of, the numbered clauses described below.

Clause 1. A plant analysis system, including a vehicle configured to traverse a field in which the plant is growing, an imaging device mechanically coupled to the vehicle, wherein the imaging device is configured to generate stereo image data associated with the plant, and a back-end computer system including a processor and a memory configured to store a machine learning algorithm that, when executed by the processor, cause the back-end computer system to receive the stereo image data from the imaging device, autonomously detect an object of interest associated with the plant based on the received stereo image data, characterize the detected object of interest, and estimate a crop yield based on the characterization of the detected object of interest.

Clause 2. The plant analysis system according to clause 1, wherein the object of interest includes a grape.

Clause 3. The plant analysis system according to either of clauses 1 or 2, wherein the imaging device includes a first lens, a second lens set a fixed distance from the first lens, thereby defining a fixed leg upon which triangulation computations can be determined, and a plurality of lights surrounding the first lens and the second lens.

Clause 4. The plant analysis system according to any of clauses 1-3, wherein the triangulation computations include a determination of at least one of a depth that includes a distance from which an object of interest is positioned relative to the imaging device.

Clause 5. The plant analysis system according to any of clauses 1-4, wherein the imaging device further includes an overdrive circuit, a hardware synchronization circuit, and a memory.

Clause 6. The plant analysis system according to any of clauses 1-5, wherein the overdrive circuit is communicably coupled to a capacitor and the plurality of lights, and wherein the overdrive circuit is configured to control a discharge of the capacitor to drive at least one light of the plurality of lights according to a predetermined parameter.

Clause 7. The plant analysis system according to any of clauses 1-6, wherein the predetermined parameter includes a microsecond flash configured to enable the imaging device to generate stereo image data as the vehicle travels at a predetermined speed through the field.

Clause 8. The plant analysis system according to any of clauses 1-7, wherein the imaging device further includes a current limiting resistor, and wherein the microsecond flash includes a current greater than one hundred amps provided via the current limiting resistor.

Clause 9. The plant analysis system according to any of clauses 1-8, further including a plurality of location indicators dispersed throughout the field, wherein the stereo image data includes location information provided via the plurality of location indicators, and wherein, when executed by the processor, the machine learning algorithm causes the back-end computer system to determine, via a geospatial visualization engine, a plurality of locations in the field associated with the received stereo image data based on the location information, categorize, via a geospatial visualization engine, the received stereo image data based on the location information, and calibrate, via the geospatial visualization engine, the received stereo image data based on the categorization.

Clause 10. The plant analysis system according to any of clauses 1-9, wherein the plurality of location indicators include a plurality of quick response codes.

Clause 11. The plant analysis system according to any of clauses 1-10, wherein when executed by the processor, the machine learning algorithm causes the back-end computer system to determine a position and orientation of the imaging device within the field based on the received stereo image data.

Clause 12. The plant analysis system according to any of clauses 1-11, wherein, when executed by the processor, the machine learning algorithm further causes the back-end computer system to correct, via an image calibration engine, parameters associated with the received stereo image data, determine, via a stereo image engine, a relative position of the grape, eliminate, via an image mosaic slicing engine, overlap associated with the stereo image data according to a temporal sequence, and extract, via a deep net extraction engine, features of the grape from the stereo image data, and determine, via a yield analytical engine, a condition of the grape based on the determined relative position of the grape and the extracted features of the grape.

Clause 13. The plant analysis system according to any of clauses 1-12, wherein the determined condition includes at least one of an age or a health associated with the grape.

Clause 14. The plant analysis system according to any of clauses 1-13, wherein the extracted feature includes at least one of a size, a color, or a type, or combinations thereof.

Clause 15. A plant analysis system, including an imaging device configured to be mechanically coupled to a vehicle configured to traverse a field in which the plant is growing, wherein the imaging device is configured to generate stereo image data associated with the plant: and a back-end computer system including a processor and a memory configured to store a machine learning algorithm that, when executed by the processor, cause the back-end computer system to receive the stereo image data from the imaging device, autonomously detect an object of interest associated with the plant based on the received stereo image data, characterize the detected object of interest, and estimate a crop yield based on the characterization of the detected object of interest.

Clause 16. The plant analysis system according to clause 15, wherein the imaging device includes a first lens, a second lens set a fixed distance from the first lens, thereby defining a fixed leg upon which triangulation computations can be determined, and a plurality of lights surrounding the first lens and the second lens.

Clause 17. The plant analysis system according to either of clauses 15 or 16, wherein the imaging device further includes an overdrive circuit communicably coupled to a capacitor and the plurality of lights, wherein the overdrive circuit is configured to control a discharge of the capacitor to drive at least one light of the plurality of lights according to a predetermined parameter.

Clause 18. The plant analysis system according to any of clauses 15-17, further including a plurality of location indicators dispersed throughout the field, wherein the stereo image data includes location information provided via the plurality of location indicators, and wherein, when executed by the processor, the machine learning algorithm causes the back-end computer system to determine, via a geospatial visualization engine, a plurality of locations in the field associated with the received stereo image data based on the location information, categorize, via a geospatial visualization engine, the received stereo image data based on the location information, and calibrate, via the geospatial visualization engine, the received stereo image data based on the categorization.

Clause 19. A method of analyzing a plant, the method including receiving, via a processor, stereo image data generated by an imaging device mechanically coupled to a vehicle configured to traverse a field in which the plant is growing, wherein the imaging device is configured to generate stereo image data associated with the plant, autonomously detecting, via the processor, a fruit associated with the plant based on the received stereo image data, characterizing, via the processor, the detected fruit, estimating, via the processor, a crop yield based on the characterization of the detected fruit, and optimizing a harvest of the fruit based on the estimated crop yield.

Clause 20. The method according to clause 19, further including correcting, via a processor, parameters associated with the received stereo image data, determining, via the processor, a relative position of the fruit, eliminating, via the processor, overlap associated with the stereo image data according to a temporal sequence, and extracting, via the processor, features of the fruit from the stereo image data, and determining, via the processor, a condition of the fruit based on the determined relative position of the fruit and the extracted features of the fruit.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

1. A plant analysis system, comprising:
a vehicle configured to traverse a field in which the plant is growing;
an imaging device mechanically coupled to the vehicle, wherein the imaging device is configured to generate stereo image data associated with the plant: and
a back-end computer system comprising a processor and a memory configured to store a machine learning algorithm that, when executed by the processor, cause the back-end computer system to:
receive the stereo image data from the imaging device;
autonomously detect an object of interest associated with the plant based on the received stereo image data;
characterize the detected object of interest; and
estimate a crop yield based on the characterization of the detected object of interest.

2. The plant analysis system of claim 1, wherein the object of interest comprises a grape.

3. The plant analysis system of claim 2, wherein the imaging device comprises:
a first lens;
a second lens set a fixed distance from the first lens, thereby defining a fixed leg upon which triangulation computations can be determined; and
a plurality of lights surrounding the first lens and the second lens.

4. The plant analysis system of claim 3, wherein the triangulation computations include a determination of at least one of a depth that includes a distance from which an object of interest is positioned relative to the imaging device.

5. The plant analysis system of claim 4, wherein the imaging device further comprises an overdrive circuit, a hardware synchronization circuit, and a memory.

6. The plant analysis system of claim 5, wherein the overdrive circuit is communicably coupled to a capacitor and the plurality of lights, and wherein the overdrive circuit is configured to control a discharge of the capacitor to drive at least one light of the plurality of lights according to a predetermined parameter.

7. The plant analysis system of claim 6, wherein the predetermined parameter comprises a microsecond flash configured to enable the imaging device to generate stereo image data as the vehicle travels at a predetermined speed through the field.

8. The plant analysis system of claim 7, wherein the imaging device further comprises a current limiting resistor, and wherein the microsecond flash comprises a current greater than one hundred amps provided via the current limiting resistor.

9. The plant analysis system of claim 2, further comprising a plurality of location indicators dispersed throughout the field, wherein the stereo image data comprises location information provided via the plurality of location indicators, and wherein, when executed by the processor, the machine learning algorithm causes the back-end computer system to:
determine, via a geospatial visualization engine, a plurality of locations in the field associated with the received stereo image data based on the location information;
categorize, via a geospatial visualization engine, the received stereo image data based on the location information; and
calibrate, via the geospatial visualization engine, the received stereo image data based on the categorization.

10. The plant analysis system of claim 9, wherein the plurality of location indicators comprise a plurality of quick response codes.

11. The plant analysis system of claim 2, wherein when executed by the processor, the machine learning algorithm causes the back-end computer system to determine a position and orientation of the imaging device within the field based on the received stereo image data.

12. The plant analysis system of claim 2, wherein, when executed by the processor, the machine learning algorithm further causes the back-end computer system to:
correct, via an image calibration engine, parameters associated with the received stereo image data;
determine, via a stereo image engine, a relative position of the grape;
eliminate, via an image mosaic slicing engine, overlap associated with the stereo image data according to a temporal sequence; and
extract, via a deep net extraction engine, features of the grape from the stereo image data; and
determine, via a yield analytical engine, a condition of the grape based on the determined relative position of the grape and the extracted features of the grape.

13. The plant analysis system of claim 12, wherein the determined condition comprises at least one of an age or a health associated with the grape.

14. The plant analysis system of claim 13, wherein the extracted feature comprises at least one of a size, a color, or a type, or combinations thereof.

15. A plant analysis system, comprising:
an imaging device configured to be mechanically coupled to a vehicle configured to traverse a field in which the plant is growing, wherein the imaging device is configured to generate stereo image data associated with the plant: and
a back-end computer system comprising a processor and a memory configured to store a machine learning algorithm that, when executed by the processor, cause the back-end computer system to:
receive the stereo image data from the imaging device;
autonomously detect an object of interest associated with the plant based on the received stereo image data;
characterize the detected object of interest; and
estimate a crop yield based on the characterization of the detected object of interest.

16. The plant analysis system of claim 15, wherein the imaging device comprises:
a first lens;
a second lens set a fixed distance from the first lens, thereby defining a fixed leg upon which triangulation computations can be determined; and
a plurality of lights surrounding the first lens and the second lens.

17. The plant analysis system of claim 16, wherein the imaging device further comprises an overdrive circuit communicably coupled to a capacitor and the plurality of lights, wherein the overdrive circuit is configured to control a discharge of the capacitor to drive at least one light of the plurality of lights according to a predetermined parameter.

18. The plant analysis system of claim 15, further comprising a plurality of location indicators dispersed throughout the field, wherein the stereo image data comprises location information provided via the plurality of location indicators, and wherein, when executed by the processor, the machine learning algorithm causes the back-end computer system to:
determine, via a geospatial visualization engine, a plurality of locations in the field associated with the received stereo image data based on the location information;
categorize, via a geospatial visualization engine, the received stereo image data based on the location information; and
calibrate, via the geospatial visualization engine, the received stereo image data based on the categorization.

19. A method of analyzing a plant, the method comprising:
receiving, via a processor, stereo image data generated by an imaging device mechanically coupled to a vehicle configured to traverse a field in which the plant is growing, wherein the imaging device is configured to generate stereo image data associated with the plant;
autonomously detecting, via the processor, a fruit associated with the plant based on the received stereo image data;
characterizing, via the processor, the detected fruit;
estimating, via the processor, a crop yield based on the characterization of the detected fruit; and
optimizing a harvest of the fruit based on the estimated crop yield.

20. The method of claim 19, further comprising:
correcting, via a processor, parameters associated with the received stereo image data;
determining, via the processor, a relative position of the fruit;
eliminating, via the processor, overlap associated with the stereo image data according to a temporal sequence; and
extracting, via the processor, features of the fruit from the stereo image data; and
determining, via the processor, a condition of the fruit based on the determined relative position of the fruit and the extracted features of the fruit.
